(19) United States
(12) Patent Application Publication
(10) Pub. No.: US 2009/0233043 A1
(43) Pub. Date: Sep. 17, 2009

(54) WATER-RESPONSIVE MECHANICAL ELEMENT AND A METHOD FOR MANUFACTURING SUCH AN ELEMENT

(75) Inventors: Kenneth David Harris, Eindhoven (NL); Cornelis Wilhelmus Maria Bastiaansen, Eindhoven (NL); Dirk Jan Broer, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,056

(22) PCT Filed: Dec. 8, 2005
(86) PCT No.: PCT/IB05/54120

§ 371 Date: Jun. 7, 2007

(30) Foreign Application Priority Data
Dec. 14, 2004 (EP) 04106533.5

(51) Int. Cl. B32B 5/12; C09K 19/02; C09K 19/38

(52) U.S. Cl. 428/105; 252/299.6

(57) ABSTRACT

This invention relates to flexible structures (401) that respond to the application of an agent. Upon application of the agent, the flexible structure bends (402) in a predetermined fashion. The flexible structure is formed from a polymer liquid crystal that is orientated to define an upper surface layer and a lower surface layer having an essentially different molecule orientation, and the polymer liquid crystal is such that a length/width ration is changed upon application of the agent. Thereby, the upper and lower surface layers respond differently to the application of the agent, resulting in bending or un-bending of the flexible structure (401).

### TECHNICAL FIELD

This invention relates to flexible structures that change shape in response to external activation.

### TECHNOLOGICAL BACKGROUND

Flexible, micro-mechanical structures known today typically respond to electric fields, heat, or light. For example, a flexible foil that is movable by means of light is disclosed by Ikeda et al in Advanced Materials, 15 no 3, pages 201-205. The foil disclosed therein is made of an azobenzene liquid-crystalline gel which, when exposed to light, bends or unbends anisotropically. The foil includes anisotropically oriented trans-azo-benzene moieties which undergo trans-cis isomerization when exposed to light of the appropriate wavelength. The cis and trans isomers have a different shape. To bring about bending (or unbending), the foil is exposed to light such that substantially all incident light is absorbed by the trans-azo-benzene moieties in a surface region of the foil leaving the bulk of the foil unexposed. Accordingly, in the surface region the dye changes shape whereas in the bulk of the foil it does not. The change in shape of the dye leads to a volume concentration selectively along one direction in the surface region whereas the volume of the bulk does not change which causes the foil to bend.

However, there is a need for flexible micro-mechanical structures that respond to alternative stimulus. In particular, there is a need for structures that respond to environmental changes such as the application of various liquids or vapors. A general requirement is that the structures should enable individual use as well as integration into larger systems of structures.

### SUMMARY OF THE INVENTION

The above need is meet by a flexible structure as defined in claim 1 below. Furthermore, advantageous manufacturing and use of such flexible structures are defined in claim 10 and 13, respectively. The appended sub-claims define advantageous embodiments in accordance with the present invention.

Hence, one aspect the present invention provides a flexible structure that comprises a polymer network. The polymer network comprises polymerized liquid crystal monomers. The flexible structure defines an upper surface layer and a lower surface layer, and the polymerized monomers are oriented such that a mean axial direction of the polymerized monomers in the upper surface layer differs essentially from a mean axial direction of the polymerized monomers in the lower surface layer. The lower and upper layer may consist of two different layers that are applied on top of each other. But it also may consist of a monolithic element where the distinction between upper and lower comes from a gradual change in property, in this case the average local molecular orientation, and/or composition going from the upper boundary to the lower boundary. The angle between the molecular orientation is typically chosen to be 90° because this give in most cases the maximum objected effects, but may also chosen to be smaller or larger, for instance for the reason that processing and fabrication might become easier. The polymerized monomers further comprise breakable secondary bonds that are breakable by application of an agent whereby the structure changes shape. Hence, our teaching is that by providing a structure as described above, we get a structure which bends when exposed to the agent. Without wishing to be bound by any theory we believe this to be a result of a change in length-width ratio of the polymerized monomers upon application of the agent. The difference in mean axial direction of the upper and lower surface layers is such that the direction of length-width changes in the upper surface layer differs essentially from that of the lower surface layer. According to one embodiment, the difference is essentially 90°, thereby ensuring an optimal bending effect in the flexible structure.

As a consequence, the upper and lower surface layer react differently to the application of the agent, making the flexible structure bend.

The present invention thus provides a flexible structure based on a polymer liquid crystal that changes shape when exposed for an environmental change. In other words, rather than being stimulated by heat, light or an electric field, the elements described herein react to a change of the environment.

According to one embodiment, the polymer network is oriented in a twisted or splayed configuration. Thereby, essentially 90° difference in the mean axial direction of the polymerized monomers is ensured, making the top and the bottom of the structure react in opposite ways with respect to expansion and contraction and thus giving it a very effective bending mode.

The degree of expansion and contraction varies between different polymer networks, as does the ratio of contraction/expansion in the axial direction versus that in the orthogonal direction. In case a large amount of the applied agent is taken up in the polymer when added thereto, the axial contraction is typically reduced and might even be zero. It is even possible for this reaction to counteract the contraction in a degree large enough to result in an expansion. However asymmetries in the axial direction versus orthogonal directions will typically lead to a large bending effect anyway.

The invention is thus based on the observation that the length/width ratio of polymerized monomers in a liquid crystalline network, containing breakable bonds, changes when these bonds are broken after being brought in contact with an agent that interferes specifically with the breakable bonds. Breakable bonds in this context are bonds that can be reversible broken and formed in the presence and the absence of a reagent. Breakable bonds can be secondary bonds like hydrogen bonds. But it can also be even weaker bonds based on dipole-dipole interactions or dipole-induced dipole interactions between molecules. However the bonds must be strong enough to enable the formation of an ordered liquid-crystalline phase at the temperature range of interest. In this context, a secondary bond refers to a bond that involves attraction between molecules but that does not involve transfer or sharing of electrons. Another type of breakable bond that can be opened reversibly in the presence of a reagent are for instance primary bonds with higher binding strengths such as ionic bonds.

In contrast, for example, primary bonds in the form of covalent bonds do not generally open reversibly. Covalent bonds are formed between atoms sharing electrons and are the building blocks for most organic compounds. They are stable and when opened with special reagents or temperature they seldom go back to the original structure. Secondary bonds such as hydrogen bridges are generally much weaker than primary bonds but are still strong enough to recombine when the conditions change and are therefore preferred in many embodiments. Ionic bonds are stronger but can be reversibly broken by a reagent that reacts even stronger with the cation or anion. Examples are salts that can be broken by the presence of an acid. The polymer networks that are used within the scope of this invention typically contain polymerized monomeric units that have the ability to undergo this reversible scission. The polymer network also, but not necessarily, may contain polymerized monomer units that exclusively are built up from covalent bonds. These units do not undergo the scission reaction but contribute to the overall reversibility. These polymerized monomers are called shape-memory-monomers and are typically being used in concentrations between 0.1 and 30 wt %.

Flexible structures in accordance with the present invention will thus exhibit an increased number of broken secondary bonds upon application of the agent. The bending effect will typically increase with an increased number of broken secondary bonds.

Breaking and restoring of secondary bonds can be identified and quatified using wee known techniques such as Fourier Transform Infrared Detection (FTIR). A characteristic property of the flexible structures in accordance with the present invention is thus that the application of an agent gives rise to anisotropic dimensional changes in the direction of the molecular orientation of the liquid crystal network. These anisotropic dimensional changes make the structure bend (or unbend) and are driven by secondary bind breakages that are measurable using, for example, FTIR.

H bridges is an example of a secondary bond, and polymerized liquid crystal monomers having H bridges has proven useful for the present invention. Hence, according to one embodiment, the breakable secondary bonds are H bridges in the polymerized liquid crystal monomers.

One mechanism that has been identified as giving rise to changes of length/width ratio upon application of an agent is polymerized monomers that make place for and incorporate molecules of the agent into monomer portions at the place of the broken secondary or ionic bonds, and thus to push the broken monomer portions apart resulting in a lengthening of the monomer. Hence, according to one embodiment, the polymerized liquid crystal monomers are extensible upon breaking of said breakable secondary bonds, such that breaking of said breakable secondary bonds makes place for molecules of said agent and incorporates said molecules of said agent in said polymerized monomers.

The polymerized liquid crystal monomer can have many different chemical compositions, and the type of agent used for breaking the bond depends on the composition used. However, H₂O has proven useful as agent for many applications, both from a chemical point of view (for example in connection with H bridges as secondary bonds) and from a user point of view (H₂O is a cheap and harmless agent to use for controlling the flexible structure). Hence, according to one embodiment, the agent comprises H₂O.

A group of polymerized monomers that has proven useful is the group of polymerized monomers having the structure R¹—X—R³, where R¹ and R³ each comprise an acrylate or methacrylate group and X is a carboxyl group or pyridyl.

According to one particular embodiment, the agent is H₂O and the polymerized monomers have the following structure

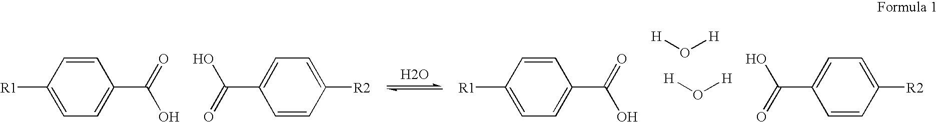

where R₁ and R₂ each contain a group selected from an acrylate group and a methacrylate group.

The above formula provides a flexible structure that responds to water or water vapor in a direct and immediate way. Alternatively, the structure might react, when used in a fluid environment, to changes in salt concentrations or to changes in the acidity of the fluid medium (pH).

A number of alternative polymerized monomers are given below in the material section of the detailed description.

According to one embodiment, the polymer network further comprises polymerized liquid crystal shape-memory-monomers that do not change length/width ratio upon application of said agent. The polymerized shape-memory-monomers thus maintain the polymer network such that the breakable secondary bonds of the polymerized monomer are restored upon removal of the agent. Thereby the flexible structure un-bends upon removal of the agent. The shape-memory-monomer is typically added in amounts ranging between 1 and 30 wt-%, and provides bonds in the resulting polymer liquid crystal that does not dissociate when the polymer is brought in contact with the agent. The addition of a polymerized shape-memory-monomer thus makes the polymer network “memorize” its original molecular orientation and hence makes the dissociation reversible with respect to the molecular order of the polymer network.

According to one embodiment, the polymerized shape-memory-monomers have the following formula

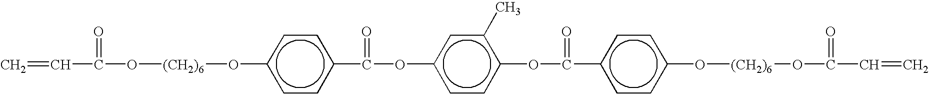

A number of alternative polymerized shape-memory-monomers are given below in the material section of the detailed description.

Another aspect of the present invention provides for the use of a polymer element as a flexible structure, wherein said polymer element comprises a polymer network, said polymer network comprising polymerized liquid crystal monomers that each has a length/width-ratio, wherein the structure defines an upper surface layer and a lower surface layer and said polymerized monomers are oriented such that a mean axial direction of the polymerized monomers in the upper surface layer differs essentially 90° from a mean axial direction of the polymerized monomers in the lower surface layer, and wherein the polymerized monomers comprise breakable secondary bonds that are breakable by application of an agent such that the length/width ratio of the polymerized monomers is changed upon application of said agent, whereby the flexible structure is operative to bend in response to the application of said agent.

As mentioned above, the agent can be in a liquid state or in a gas state. According to one particular embodiment, the agent is H₂O.

Yet one aspect of the present invention provides a method of manufacturing a flexible structure that responds to the application of an agent. The method involves the steps of selecting a polymer liquid crystal that respond to the application of an agent by anisotropic expansion or contraction, and forming the flexible structure out of said polymer liquid crystal.

The flexible structure can be formed from polymer foil having a desired molecule orientation. In such case, the foil can be patterned using for example laser-cutting or etching.

However, according to one embodiment, the polymer liquid crystal is formed by polymerizing a liquid crystal monomer. The polymerization step can, for example, involve photo polymerization.

The orientation of the polymerized liquid crystal monomer can, for example, be controlled using rubbed substrates, the rubbing directions of which will determine the surface orientation of the polymerized monomers. Alternatively, surface-active agents may be applied to the substrate in order to ensure, for example, a perpendicular orientation of the molecules at the substrate surface. Thereby it is possible to provide splayed orientations (one surface having perpendicular orientation and the reverse surface having a uniaxial, parallel orientation) or twisted orientations (parallel orientation with for example 90° twist from one side to the reverse side).

Hence, according to one embodiment, the step of forming the polymer liquid crystal involves arranging the polymerized liquid crystal monomer between surfaces that induce a desired liquid crystal molecule orientation in the polymer liquid crystal.

As described above, the polymer network may include different types of polymerized monomers, for example a monomer and a shape-memory-monomer. In such case, a suitable mixture of those monomers is co-polymerized during polymerization. A flexible structure as described above can be used, for example, as an actuator, an artificial muscle, or as a shutter or valve. It can also be used to detect certain species. The mechanical deformation can be analyzed by means of, for instance, changes in light reflection or changes in electrical capacitance or by making or breaking an electrical connection between to electrodes. Furthermore, multiple elements can be patterned into an array enabling patterned switching elements. Such an array can also be miniaturized and integrated in electronic, opto-electronic or microfluidic devices.

### BRIEF DESCRIPTION OF THE DRAWINGS

In the following, embodiments of the present invention will be described in detail, with reference to the accompanying, exemplifying drawings on which:

FIGS. 1a and 1b illustrates a polymer liquid crystal network with no agent added (1a), and with an agent added (1b).

FIG. 2 illustrates a cross-section of a polymer liquid crystal having a splayed molecule orientation, and how it reacts to the application of an agent.

FIG. 3 illustrates a cross-section of a polymer liquid crystal having a twisted molecular orientation.

FIG. 4 illustrates a cross-section of a flexible structure, and how it reacts to the application of an agent.

FIG. 5 illustrates a flexible structure that reacts differently to the application of an agent at the bottom side compared to the application of an agent at the upper side.

FIG. 6 illustrates cross-sections of an array of flexible structures.

FIGS. 7a and 7b illustrates a micro-fluidic system having two flexible structures and being in a first state (7a) and a second sate (7b), respectively.

### DETAILED DESCRIPTION OF EMBODIMENTS

The invention is advantageously manufactured using polymer liquid crystal. A polymer liquid crystal can be formed, for example, by polymerizing monomers having a well-defined liquid crystal liquid crystal molecule orientation.

### Materials

In the following, a number of feasible polymerized monomers and shape-memory-monomers are exemplified.

### Monomers

According to one embodiment, as described above, the polymer liquid crystal is formed from a monomer that owes its liquid crystalline behavior to hydrogen bridges which form secondary bonds that break in contact with water molecules. The polymer liquid crystal might, for example, have the structure and react as illustrated by Formula 1 above. An example of a suitable monomer is a molecule where R₁ and R₂ contain an acrylate group, e.g. CH₂═CH—COO—(CH₂)₆—O—, or a methacrylate group.

In its monomeric state, in the absence of water, this monomer is liquid crystalline and can be processed to form an oriented liquid-crystalline network, for example by photo polymerization of the monomer while aligned between rubbed polyimide substrates. In the polymerized state, R₁ and R₂ are part of, or attached to, the polymer network.

The same principle can be used for other types of hydrogen bridges, and other agents than water can be used for breaking the bonds. Examples of other ordered structures containing hydrogen bridges are based on carboxylic acid groups and pyridyl:

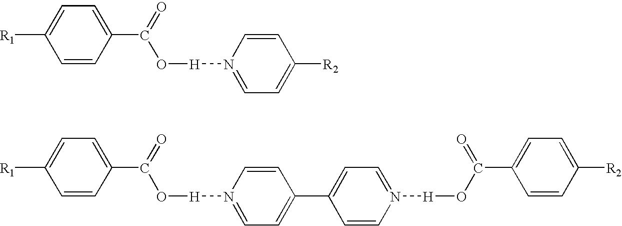

In general, the monomers should have a liquid crystalline phase and should be polymerizable. Furthermore, the polymerized monomer must provide breakable bonds, for example in the form of a hydrogen bonding component. The following is an example of a polymerized monomer reacting to water:

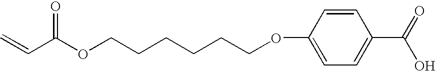

An alternative polymerized monomer that forms a dimer because of hydrogen bonding giving it its mesogenic (liquid crystalline) properties is given below:

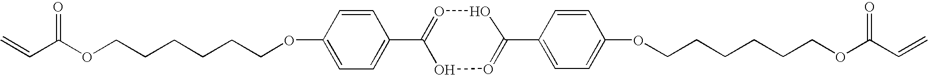

In this case a spacer (is the unit between the oxygen of the acrylate and the oxygen of phenyl group) length of six carbons has been chosen. However, there are many other examples with different number of carbon atoms, e.g. 3 or 11. Also mixtures are possible lowering the processing temperature.

The following compound forms a liquid crystalline phase because the central molecule connects the two outer molecules by hydrogen bridges. These bridges are stronger than the ones based on carboxylic acids that are exemplified above. Note that for the formation of these bonds two different molecules are needed which should be added to the reactive mixture in a 1:1 molar ratio.

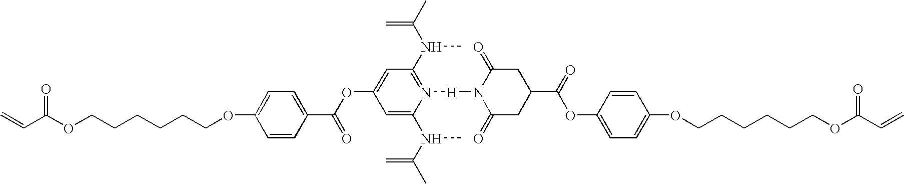

Preferably this polymerized monomer ‘opens’ with molecules that form energetically more favorable bonds such as strong acids rather than water alone. The agent can, for example, be p-toluene sulfonic acid.

As an alternative, a three-molecule complex can be chosen:

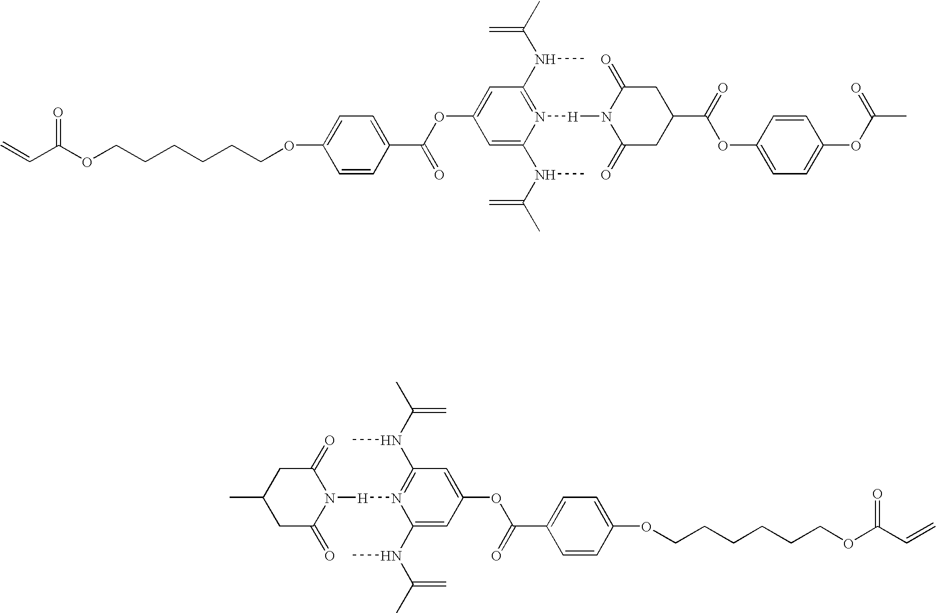

Also in this case strong acids can break the hydrogen bridges. However, when the central unit is removed from the polymer film (this can be done as soon as it is not attached no longer to the polymer network) a permanent volume change takes also permanently changing the shape of the length/width ratio.

An example of an ionic binding is given by the following salt:

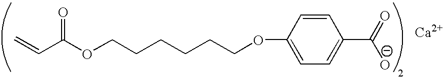

Instead of Calcium also for instance Magnesium or Barium can be used. These ionoic bonds can be broken by e.g. strong acids, such as p-toluene sulfonic acid, hydrogen chloride, sulfuric acid, etc. as agent.

Rather than using acrylates

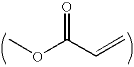

as the polymerizable groups also other functionalities can be applied to make the polymer. Examples are

### Methacrylates:

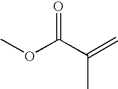

### Vinyl Ethers:

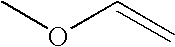

### Epoxides:

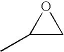

### Oxetanes:

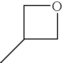

Thiol-enes: monomers with either —SH or —CH═CH₂ or monomers containing both.

Acrylates, methacrylates and thiol-enes cure with a free-radical mechanism. Vinyl ethers, epoxides and oxetanes cure via a cationic mechanism. As is generally known in the art, these compounds therefore require somewhat different initiators.

### Shape-Memory-Monomers

In case a memory-function is desired, a co-polymer providing breakable bonds and “memory” bonds, is advantageously used. In such cases, a shape-memory-monomer is typically added in an amount ranging between 1 and 30 wt-%. For example, the monomer specified by Formula 2 (above) can be used as shape-memory-monomer. Using this shape-memory-monomer, water can be used as agent for breaking hydrogen bridges and, thus, for changing the length/width ratio. When the water is removed, due to the inclusion of a shape-memory-monomer in the polymerized co-polymer, the process of breaking and forming of hydrogen bonds is reversed and the film retains it original dimension and shape.

However, there are many monomers that could be employed as shape-memory-monomer. For example, in addition to the monomer given by Formula 2 itself (above), similar monomers except with carbon chains of lengths different than 6 (e.g. 3-11), or with the central methyl group removed. It is also possible to use monomers with a different number of benzene rings, and monomers having different connecting or reactive groups. The general requirement is that it must be polymerizable on both ends (with e.g. acrylates, methacrylates, or epoxies), it must blend with the monomer, and preferably it should be liquid crystalline before polymerization.

Examples of shape-memory-monomers that promote reversibility of the dimensional changes are:

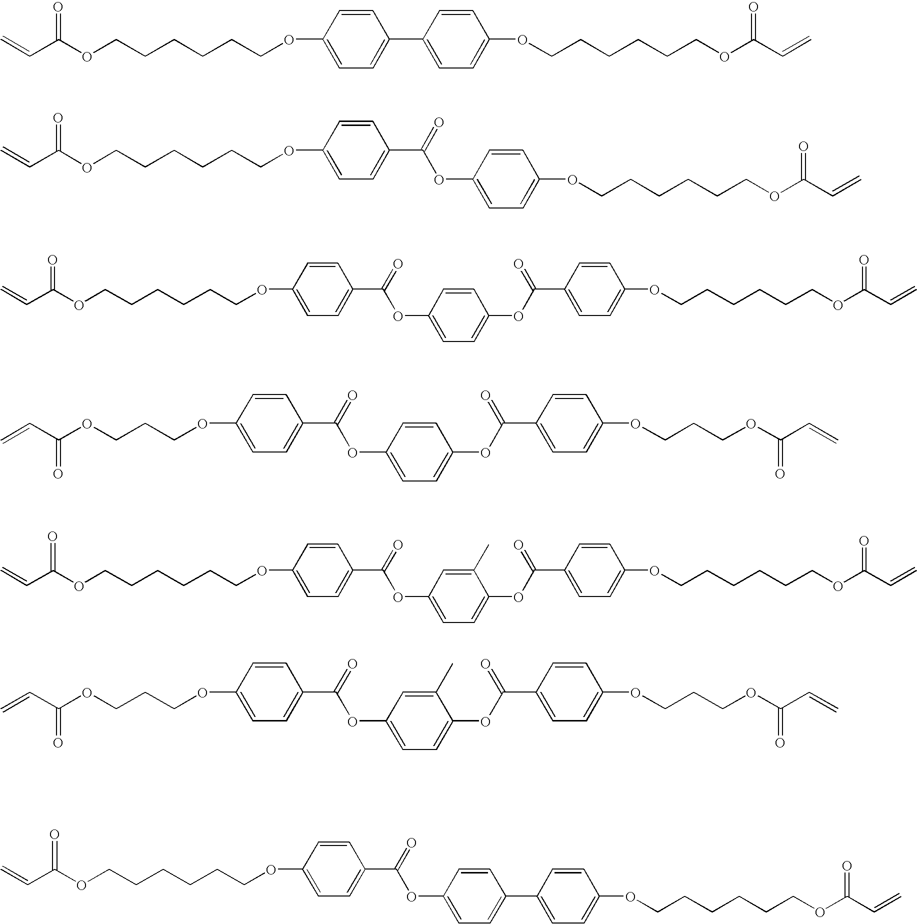

Because of their mesogenic character these examples normally stabilize the liquid crystalline phase in the monomeric state. More examples of polyfunctional liquid crystalline monomers can be found in literature.

However, rather than using polyfunctional monomers with mesogenic properties, also monomers can be used that are non-mesogenic. In general these monomer will destabilize liquid crystallinity of the monomer mixture. But especially when they are applied in relatively low concentrations this reduction is not a problem. Also because in general the melting temperature is decreased as well. (Processing of liquid crystalline monomers typically proceed in a limited temperature range. The monomer blend often is crystalline at room temperature and must be heated to melt. When heated to too high temperature the monomer blend becomes isotropic and looses its molecular order). Examples of other monomers that can be used as shape-memory-monomer are hexanediol diacrylate, tripropyleneglycol diacrylate and trimethylolpropane triacrylate with the following respective structures:

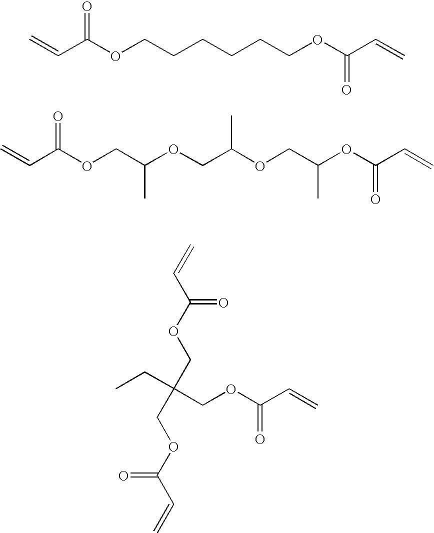

Furthermore, similar to the monomers, other functionalities except than acrylates can be applied as the polymerizable groups to make the polymer. Examples include methacrylates, vinyl ethers, epoxides, oxetanes, and thiol-enes.

### Agents

Examples of other agents except H₂O for breaking the breakable bonds include, for instance, compounds with strong H-bridges that form pyridyl groups and that are dissolved in a water-free solvent. The strong H-bridge between the pyridyl moiety and the carboxylic moiety breaks the existing intermolecular H-bridges of the carboxylic units in the polymer chain:

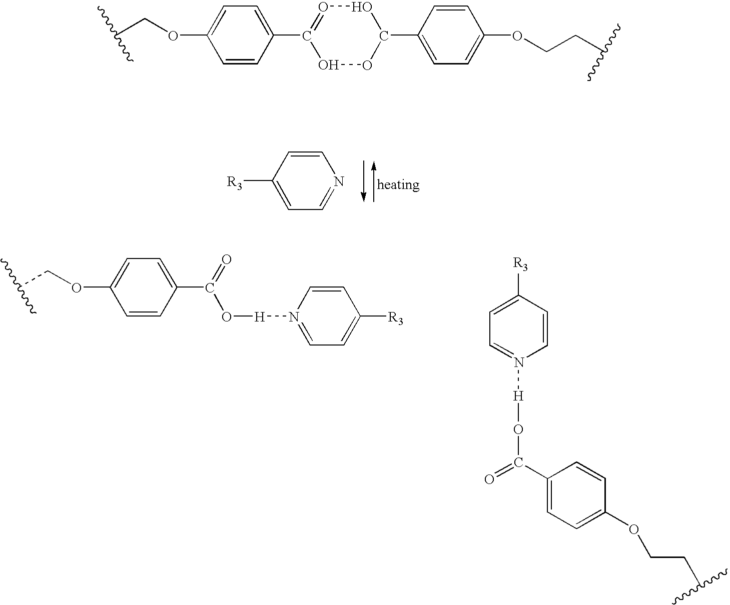

This process is reversible by simple heating, making the H-bridges weaker and less specific. Thereby it is possible to remove the pyridyl containing compounds, e.g. by evaporation or by flushing with solvent, making the film retaining its original structure.

### Molecular Orientation

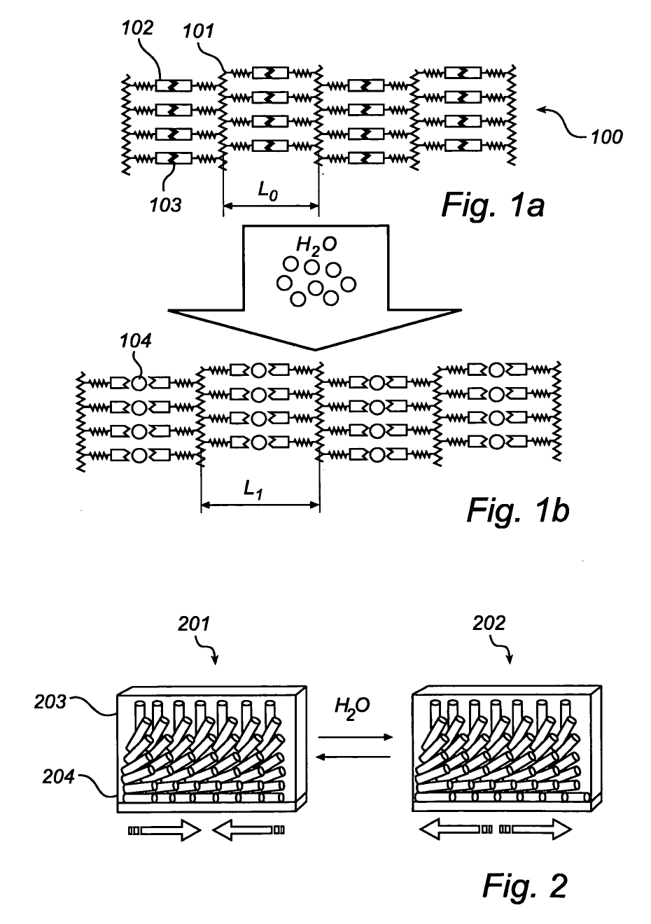

The bending effect of the structure is typically enhanced by a suitable molecular orientation in the flexible structure. The molecular orientation can be that of the polymer main chain or that of side groups to the molecular chain. In a preferred embodiment the molecular orientation relates to the alignment of mesogenic units that are connecting polymer main chains. The mesogenic units are rod-like molecular moieties that bridge the reactive polymerizable groups indicated in the molecular structures given above. An example of a polymer network 100 is illustrated in FIGS. 1a and 1b. The polymer network comprises mesogenic units 103 that each has a central breakable bond, and that are aligned in, for example, a twisted or splayed orientation. However, as stated above, the polymer main chains 101 are not necessarily aligned. Furthermore, the polymer network comprises flexible spacers 102 that connect the mesogenic units 103 with the polymer main chains 101.

The structure typically has an elongated, extended shape, and can, for example be formed out of a polymer film having a suitable molecule orientation.

For example, the molecules can have a twisted orientation, where the molecules rotate 90° over the cross-section of the film and where the molecules on average remain aligned in the plain of the film, or it can be a splayed orientation, where the molecules are aligned planar to the surface at one side of the film and perpendicular to surface at the reverse side of the film.

FIG. 2 illustrates a cross-section 201 of a polymer liquid crystal structure having a splayed orientation. At the bottom face of the structure, the average molecule orientation 204 is horizontal (parallel with the structure), and at the top face of the structure, the average molecule orientation 203 is vertical (orthogonal with the structure). However, when adding an agent 202 (H₂O in this case), the average distance between the polymer main chain increases with ΔL=Lₜ−Lₒ thus effectively increasing also the macroscopic length. This is schematically shown in FIG. 1b.

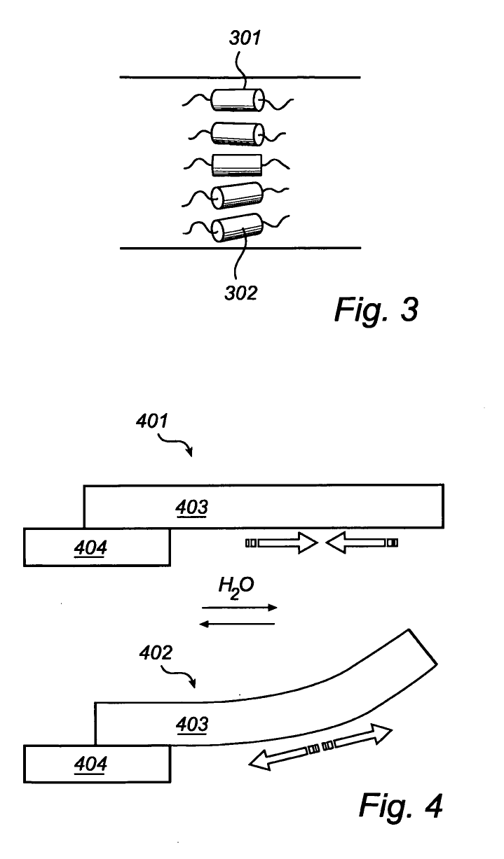

FIG. 3 illustrates a cross-section of a twisted polymer orientation, where the orientation is parallel with the structure but twisted 90° in the upper surface layer 301 compared to the lower surface layer 302.

When the molecules that undergo the dimensional change have a different orientation at the top of the film as compared with the bottom of the film, the film bends due to this dimensional change. As described above, the different orientation can be in a so-called splayed configuration. In that case the film will expand in a lateral way at the location where the molecules are aligned parallel with the structure, and the film will expand in the direction perpendicular to the film where the molecular orientation is perpendicular to the film as well. The result is that when films with this configuration are brought in contact with the agent, they always will bend in the direction of the molecular orientation of the planar molecules and the bending direction towards the bottom of the film as illustrated in FIG. 2. The phenomenon is illustrated on a macro-level in FIG. 4, where a cross-section of a flexible element is illustrated. The flexible structure 401, 402 basically consists of a movable element 403 that resides on a base-mounting 404. The movable element is formed of polymer liquid crystal having, for example, a splayed molecule orientation as illustrated in FIG. 1. When exposed to an agent (in this case H₂O), the length/width ration of the polymer is changed and the element changes shape from a straight shape 401 to a bent shape 402.

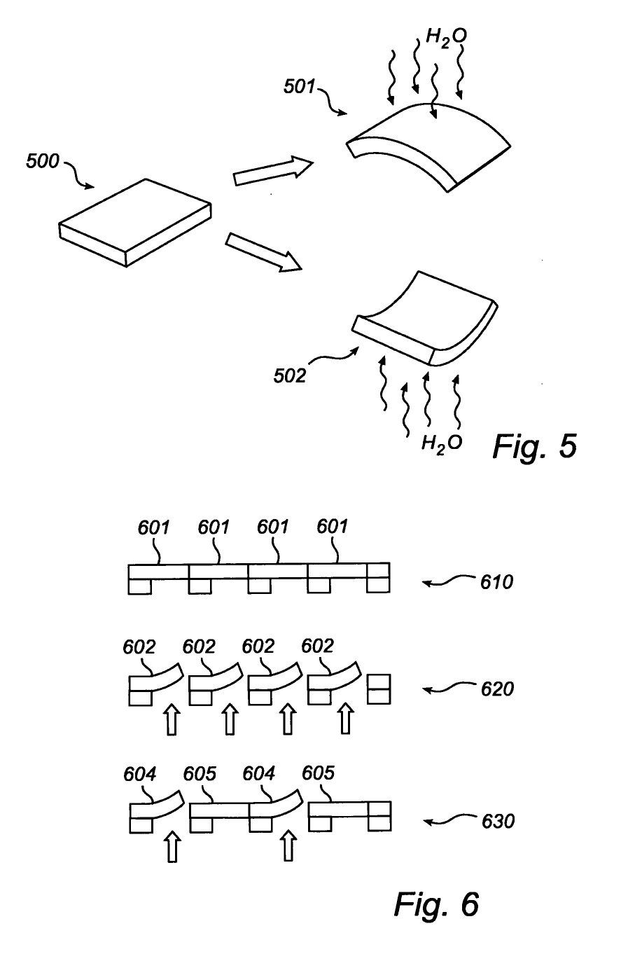

Alternatively, in case the difference in molecular orientation is a twisted configuration, the average molecular orientation of the mesogenic units at the bottom of the film is on the average orthogonal to that at the top of the film. In such structures the bending direction is not fixed since both surfaces have the tendency to bend away in the direction of the orientation. This would result in saddle-like geometries that are impossible to form because of geometrical reasons. A surprising observation is however that the film always bends away from the surface that experiences the agent first. Hence, as illustrated in FIG. 5, if the agent comes from the top of the film 500, the film 500 bends in the direction 501 of the bottom with the bending direction parallel to the average molecular orientation at the top of the film. Visa versa, when the agent comes from the bottom the film bends to the top in the direction 502 parallel to the average molecular orientation at the bottom of the film.

FIG. 6 illustrates an array 610, 620, 630 of four flexible structures. The structures 601 can all be in a straight state, rendering an all-closed array 610. Alternatively, they can be all be in a bent state 602, or some structures 604 can be in a bent state while others 605 are in a straight state. Addressing of the individual structures can for instance performed by changing their composition. Differences in concentration of the base molecule provide a difference in response depending on the concentration of the agent. Because the films are made by photo polymerization, they can easily be structured and complex arrays with different responses are made by coating and lithographic exposure and dissolving of the unreacted monomers in two or more consecutive steps with different monomer compositions. As a result in an array as shown in FIG. 3 and in case of water responsive elements less or more pores are opened depending on the vapor pressure of water.

In another example, flexible structures are part of a micro-fluidic system where the elements have the function of an automated valve. Here use is made of their high sensitivity towards water.

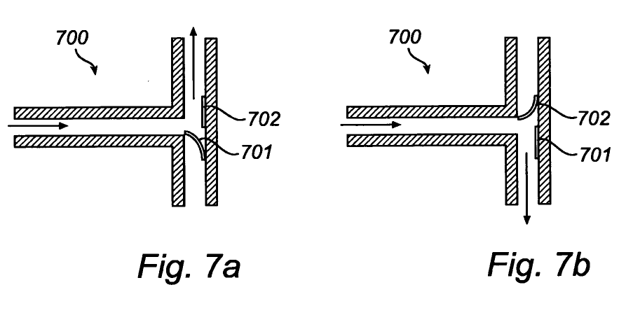

FIGS. 7a and 7b illustrates such a micro-fluidic system 700, in the form of a T-valve comprising a first flexible structure 701 and a second flexible structure 702. In case the channel is fed with a water-free liquid, such as purified ethanol, structure 701 closes the downward channel and the liquid is forced to go upwards. As soon as the ethanol becomes contaminated with water the liquid is forced to follow a different path as structure 702 closes and structure 701 opens. Thereto structure 701 is made such that it bends in the dry state and structure 702 is made such that it bends in the wet state. Straight structures that bend in the wet state are described as above, for instance by making use of a splayed configuration. Structures that are already bended in the dry state and that become straight when wet can be prepared by adding a small amount of a stilbene containing shape-memory-monomer to the monomer mixture. During polymerization this unit tends to contract. When this formulation is brought in the splayed configuration it bends the film to the side where the molecules are planar aligned.

An example of a shape-memory-monomer that can undergo a permanent change in it conformation such that it provides bending to a splayed film is:

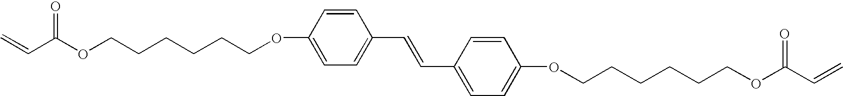

During polymerization this molecule is built in to the network. At the same time, it undergoes a conversion from its trans configuration to its cis configuration thereby changing the average end-to-end distance of the molecule:

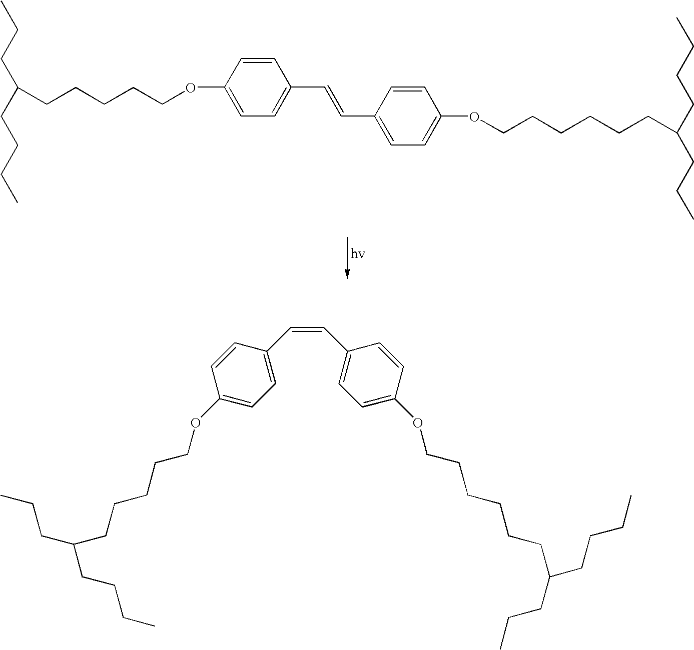

In another embodiment the elements are provided with a conductive material such that upon bending of the element two opposite electrodes are shortcut. Since a flexible structure compares to a relay that opens or closes as function of the concentration of the agent. Such a device can be used for detection of the agent, but it can also be used to activate other devices such as shutters, windows, valves, pump etc. when brought into contact with the agent.

### EXAMPLE

An example of the fabrication of free-standing flexible structures (beams) in accordance with the present invention, having an ordered molecule structure with a 90° twist of the molecules over the cross-section and responding to water is given in the following.

A reactive liquid crystalline monomer blend is made of the following composition:

| | Amount |
|---|---|
| Compound | (wt-%) |
| 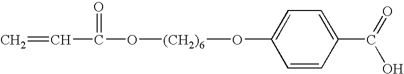 | 94 |
| 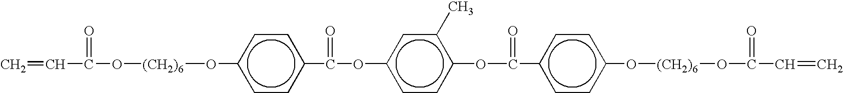 | 5 |
| 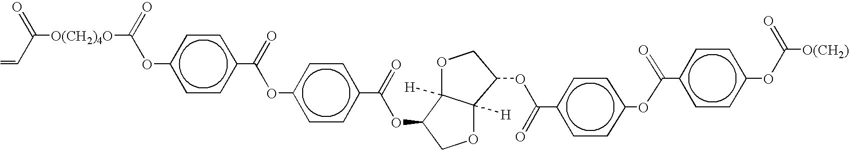 | 0.1 |
| 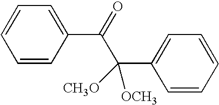 | 0.9 |

The first compound is a monomer, the second compound is a shape-memory-monomer, the third compound is a chiral dopant, and the fourth compound is a photoinitiator. The chiral dopant ensures that all molecules turn in the same direction and is thus used for twisted molecule orientations. The photoinitiator is such that it splits into two free radicals when exposed to ultraviolet radiation, thereby initiating a chain reaction polymerization process.

Two 50×50 mm glass substrates are coated with a 30 nm polyimide layer that is spin coated from a solution in N-methyl pyrrolidine, after which the polyimide is uniaxially rubbed using for example a velvet cloth. The rubbing provides a uniaxial alignment of a liquid crystal that is brought in contact with the rubbed polyimide.

The glass plates are subsequently mounted in a cell construction with the rubbed polyimide films facing each other. Glass fiber spacers having a diameter of e.g. 10 micrometers are used to space the substrates apart, and the rubbing directions of the respective polyimide layers are arranged perpendicular to each other.

The spacing is subsequently filled at 100° C. with the monomer blend using capillary forces. After cooling to 30° C. the sample is polymerized by a 30 minutes exposure of UV light from a fluorescent UV lamp at a distance of 20 cm (Philips PL10, 5 mW/cm²). After UV exposure the temperature of the sample is raised to 80° C. for 5 minutes to postcure the sample after which it is cooled to room temperature again. At room temperature the glass plates are removed and freestanding polymer beams of 20×5 mm are cut from the resulting polymer liquid crystal film.

Cutting can be performed using, for example, a knife. Alternatively, the structures can be patterned using microcontact printing to stamp structures onto their substrates, or photo polymerization through a mask, leaving removable, non-reacted monomers at unexposed areas.

The resulting polymer beams are birefringent, supporting the assumption of an ordered structure, and rotate the direction of polarized light, supporting the assumption of a twisted structure. When this film is brought into contact with water, no mechanical response is observed. However, when the same film first is soaked into a 2 N KOH solution and dried it responds directly to water by bending. Soaking with KOH enables water to be anisotropically absorbed by the polymer, resulting in lengthening of the molecules. In fact, already the presence of water vapor is enough for the films to bend over a radius of 5 mm as is obvious simply by moving the film towards a water surface. Moving the film upwards, away from the water surface, it responds directly by straighten itself again.

Hence, in essence, the present invention relates to flexible structures 401 that respond to the application of an agent. Upon application of the agent, the flexible structure bends 402 in a predetermined fashion. The flexible structure is formed from a polymer liquid crystal that is orientated to define an upper surface layer and a lower surface layer having an essentially different molecule orientation, and the polymer liquid crystal is such that a length/width ration is changed upon application of the agent. Thereby, the upper and lower surface layers respond differently to the application of the agent, resulting in bending or un-bending of the flexible structure 401.

1. A flexible structure (401, 402) comprising a polymer network, said polymer network (100) comprising polymerized liquid crystal monomers (102), wherein the structure defines an upper surface layer (203) and a lower surface layer (204) and said polymerized monomers are oriented such that a mean axial direction of the polymerized monomers in the upper surface layer (203) differs essentially from a mean axial direction of the polymerized monomers in the lower surface layer (204), and wherein the polymerized monomers (102) comprise breakable secondary bonds (103) that are breakable by application of an agent (104).

2. A flexible structure (401, 402) according to claim 1, wherein in said polymerized monomers (102) are oriented such that the mean axial direction of the polymerized monomers in the upper surface layer (203; 301) differs essentially 90° from the mean axial direction of the polymerized monomers in the lower surface layer (204; 302).

3. A flexible structure (401, 402) according to claim 1, wherein the polymerized liquid crystal monomers (102) are extensible upon breaking of said breakable secondary bonds, such that breaking of said breakable secondary bonds makes place for molecules of said agent (104) and molecules of said agent (104) are incorporated in said polymerized monomers (102).

4. A flexible structure (401, 402) according to claim 1, wherein said breakable secondary bonds (103) are H bridges in the polymerized liquid crystal monomers (102).

5. A flexible structure (401, 402) according to claim 1, wherein the agent (104) comprises H₂O.

6. A flexible structure (401, 402) according to claim 1, wherein said polymer network (100) further comprises polymerized monomers that do not react with said agent such as to break secondary bonds thereof.

7. A flexible structure (401, 402) according to claim 1, wherein said polymerized monomers (102) have the structure R¹—X—R³, where R¹ and R³ each comprise an acrylate, methacrylate epoxide, vinylether, oxetane group or a thiol group in combination with a vinyl group, and where X is formed by two carboxyl groups or by one carboxyl group and one pyridyl group.

8. A flexible structure (401, 402) according to claim 1, wherein said agent (104) is H₂O, and said polymerized monomers (102) have the following structure 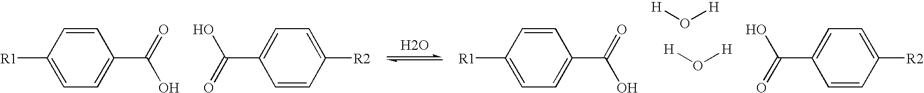
where R₁ and R₂ each contain a group selected from an acrylate group and a methacrylate group.

9. A flexible structure (401, 402) according to claim 6, wherein the shape-memory-monomers have the following formula

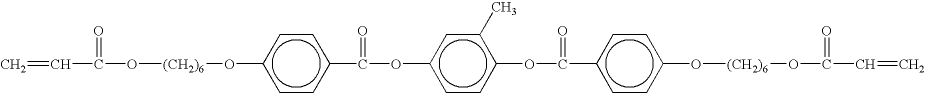

10. Use of a polymer element as a flexible structure (401, 402), wherein said polymer element comprises a polymer network (100), said polymer network comprising polymerized liquid crystal monomers (102) that each has a length/width-ratio, wherein the flexible structure (401, 402) defines an upper surface layer (203; 301) and a lower surface layer (204; 302) and said polymerized monomers (102) are oriented such that a mean axial direction of the polymerized monomers in the upper surface layer (203; 301) differs essentially 90° from a mean axial direction of the polymerized monomers in the lower surface layer (204; 302), and wherein the polymerized monomers comprise breakable secondary bonds (103) that are breakable by application of an agent (104) such that the length/width ratio of the polymerized monomers (102) is changed upon application of said agent (104), whereby the flexible structure (401, 402) is operative to bend in response to the application of said agent (104).

11. Use of a polymer element as defined in claim 10, wherein said agent (104) is in one of liquid state and gas state.

12. Use of a polymer element as defined in claim 10, wherein said agent (104) is H₂O.

13. Method of manufacturing a flexible structure (401, 402) that responds to the application of an agent (104), said method including the steps of:
selecting a polymer liquid crystal that respond to the application of an agent by anisotropic expansion or contraction,
forming the flexible structure (401, 402) out of said polymer liquid crystal.

14. Method according to claim 12, including the step of forming said polymer liquid crystal by polymerizing a liquid crystal monomer.

15. Method according to claim 14, wherein the step of forming said polymer liquid crystal involves arranging the liquid crystal monomer between surfaces that induce a desired liquid crystal molecule orientation in the polymer liquid crystal.

16. Method according to claim 15, wherein the liquid crystal monomer is a mixture of monomers.
